(19) United States
(12) Patent Application Publication
(10) Pub. No.: US 2025/0287275 A1
(43) Pub. Date: Sep. 11, 2025

(54) Handling Security Keys for Inter-CU LTM in a Secondary Node

(71) Applicant: Apple Inc., Cupertino, CA (US)

(72) Inventors: Naveen Kumar R PALLE VENKATA, San Diego, CA (US); Fangli XU, Beijing (CN); Haijing HU, Los Gatos, CA (US); Shu GUO, Beijing (CN); Yuqin CHEN, Beijing (CN)

(21) Appl. No.: 19/073,714

(22) Filed: Mar. 7, 2025

Related U.S. Application Data
(60) Provisional application No. 63/562,528, filed on Mar. 7, 2024.

(51) Int. Cl. H04W 36/00; H04W 12/041; H04W 72/231

(52) U.S. Cl. CPC H04W 36/0069; H04W 12/041; H04W 72/231

(57) ABSTRACT

An apparatus configured to process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM), process, based on signaling received from the SN, a medium access control (MAC) control element (MAC-CE) that triggers a SN change to a first candidate SN, the MAC-CE including a counter value for deriving a security key of the first candidate SN, derive the security key for the first candidate SN based on the counter value and perform operations associated with the SN change from the SN to the first candidate SN.

### PRIORITY/INCORPORATION BY REFERENCE

This application claims priority to U.S. Provisional Application Ser. No. 63/562,528 filed on Mar. 7, 2024 and entitled, “Handling Security Keys for Inter-CU LTM in SN,” the entirety of which is incorporated by reference herein.

### BACKGROUND

New Radio (NR) supports multiple different types of handover to change a serving cell for a user equipment (UE). In Rel-18, lower layer triggered mobility (LTM) was introduced to support a serving cell change via layer 1 (L1) or layer 2 (L2) signaling. In LTM, a L2 medium access control (MAC) control element (MAC-CE) may trigger the handover.

In Rel-18, LTM is limited to scenarios where a centralized unit (CU) of the source cell and the target cell remains the same (intra-CU handover). Thus, there is no change in security keys for the UE to communicate with the target cell. However, it is an objective to support inter-CU LTM, which requires the exchange of security-related information so that the security key for the target cell may be derived by the UE.

### SUMMARY

Some example embodiments are related to an apparatus having processing circuitry configured to process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM), process, based on signaling received from the SN, a medium access control (MAC) control element (MAC-CE) that triggers a SN change to a first candidate SN, the MAC-CE including a counter value for deriving a security key of the first candidate SN, derive the security key for the first candidate SN based on the counter value and perform operations associated with the SN change from the SN to the first candidate SN.

Other example embodiments are related to an apparatus having processing circuitry configured to process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM) and a counter lookup table mapping counter index values to counter values, process, based on signaling received from the SN, a medium access control (MAC) control element (MAC-CE) that triggers a SN change to a first candidate SN, the MAC-CE including a first counter index value, determine a first counter value associated with the first counter index value for deriving a security key of the first candidate SN, derive the security key for the first candidate SN based on the counter value and perform operations associated with the SN change from the SN to the first candidate SN.

Still further example embodiments are related to an apparatus having processing circuitry configured to process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM) and a respective list of counter values associated with each candidate SN, determine to trigger a SN change to a first candidate SN, derive a security key of the first candidate SN based on a first counter value in a first list of counter values associated with the first candidate SN and perform operations associated with the SN change from the SN to the first candidate SN.

Additional example embodiments are related to an apparatus having processing circuitry configured to process, based on signaling received from a master node (MN), a counter value for deriving a security key of a candidate secondary node (SN) and generate, for transmission to a user equipment (UE), a medium access control (MAC) control element (MAC-CE) that triggers a SN change to the candidate SN, the MAC-CE including the counter value for deriving the security key of the candidate SN.

More example embodiments are related to an apparatus having processing circuitry configured to generate, for transmission to a secondary node (SN), a first security key wherein the first security key is generated based on an initial counter value, generate, for transmission to a user equipment (UE), a message comprising the initial counter value, determine the UE is to perform an SN change from the SN to a candidate SN, generate, for transmission to the candidate SN, a second security key wherein the second security key is generated based on a new counter value and generate, for transmission to the SN, the new counter value for deriving the second security key of the candidate SN.

### BRIEF DESCRIPTION OF THE DRAWINGS

FIG. 1 shows an example signaling diagram for addition/modification of a secondary node (SN) in dual-connectivity (DC) operations according to existing specifications.

FIG. 2 shows an example MAC-CE for triggering a secondary node (SN) change and providing a counter value according to various example embodiments.

FIG. 3a shows a signaling diagram for an inter-CU secondary node (SN) change initiated by a master node (MN) for a user equipment (UE) in NR-DC operation, the SN change being triggered by a MAC-CE in a lower layer triggered mobility (LTM) operation, according to various example embodiments.

FIG. 3b shows a signaling diagram for an inter-CU secondary node (SN) change initiated by a SN for a user equipment (UE) in NR-DC operation, the SN change being triggered by a MAC-CE in a lower layer triggered mobility (LTM) operation, according to various example embodiments.

FIG. 4 shows an example MAC-CE for triggering a secondary node (SN) change and providing a counter index value according to various example embodiments.

FIG. 5a shows a signaling diagram for an inter-CU secondary node (SN) change initiated by a master node (MN) for a user equipment (UE) in NR-DC operation, the SN change being triggered by a protected MAC-CE in a lower layer triggered mobility (LTM) operation, according to various example embodiments.

FIG. 5b shows a signaling diagram for an inter-CU secondary node (SN) change initiated by a SN for a user equipment (UE) in NR-DC operation, the SN change being triggered by a protected MAC-CE in a lower layer triggered mobility (LTM) operation, according to various example embodiments.

FIG. 6 shows a signaling diagram for an inter-CU secondary node (SN) change initiated by a user equipment (UE) in NR-DC operation according to various example embodiments.

FIG. 7 shows an example network arrangement according to various example embodiments.

FIG. 8 shows an example user equipment (UE) according to various example embodiments.

FIG. 9 shows an example base station according to various example embodiments.

### DETAILED DESCRIPTION

The example embodiments may be further understood with reference to the following description and the related appended drawings, wherein like elements are provided with the same reference numerals. The example embodiments relate to security handling for lower layer triggered mobility (LTM) operations in which a user equipment (UE) is to switch from a source cell provided by a first centralized unit (CU) to a target cell provided by a second CU, e.g., inter-CU LTM. In particular, the example embodiments relate to a scenario where New Radio (NR) dual-connectivity (NR-DC) is configured for the UE and the UE is to switch from a source secondary node (SN) provided by the first CU to a target SN provided by the second CU.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange signaling and/or data with the network. Therefore, the UE as described herein is used to represent any electronic component.

The example embodiments are also described with reference to a 5G New Radio (NR) network. However, reference to a 5G NR network is merely provided for illustrative purposes. The example embodiments may be utilized with any network implementing dual connectivity (DC) functionalities similar to those described herein. Therefore, the 5G NR network as described herein may represent any type of network implementing DC functionalities as the 5G NR network, e.g. 5G-Advanced networks, 6G networks, etc.

The example embodiments are also described with regard to dual connectivity (DC). DC generally refers to a scenario in which the UE is connected to a master node (MN) and a secondary node (SN). The MN may be one of multiple nodes that form a master cell group (MCG) and the SN may be one of multiple nodes that form a secondary cell group (SCG). The nodes of the cell groups may be further characterized by their roles within their respective cell group. In the examples provided below, reference is made to various different types of cells. Each of these different types of cells are defined in third generation partnership program (3GPP) Technical Specifications (TS). For instance, the MCG may comprise a primary cell (PCell) and zero or more secondary cells (SCells) and the SCG may comprise a primary secondary cell (PSCell) and zero or more SCells. In some cases, the terms “MN” and “PCell” may be used interchangeably or the terms “SN” and “PSCell” may be used interchangeably.

The example embodiments are further described with regard to handover (HO) and/or SN changes. A traditional handover may be initiated by a UE or by a serving cell. In UE-initiated HO, the UE may evaluate various predefined conditions in view of its RRM measurements and, when the conditions are met, may request a HO. The serving cell receiving the HO request may evaluate whether a handover should be performed for the UE based on various potential factors and, if it is determined that a handover should be performed, initiate the handover process. In network-initiated HO, the serving cell may determine the handover should be performed without first receiving the UE request, e.g., for purposes such as load balancing or radio resource optimization. The serving cell (source cell) may select a target cell and the target cell may be prepared for HO of the UE. The serving cell may then transmit a handover command to the UE via radio resource control (RRC) reconfiguration and provide parameters for the target cell so that the UE may switch to the target cell without significant interruption to the network connection, e.g., without requiring an RRC reestablishment procedure.

A handover may be performed within a same centralized unit (CU) (intra-CU handover) or across different CUs (inter-CU handover). A CU supports higher layers of the 5G protocol stack, e.g., service data adaptation protocol (SDAP), packet data convergence protocol (PDCP) and radio resource control (RRC) while a distributed unit (DU) supports lower layers of the 5G protocol stack, e.g., radio link control (RLC), medium access control (MAC) and the physical layer (PHY). One CU may control the respective DUs of multiple base stations, e.g., gNBs.

In an intra-CU handover, there is no change in security keys for the UE to communicate with the target cell. In an inter-CU handover, security-related information may be exchanged so that the security key for the target cell may be derived by the UE.

The security key is managed by the access and mobility management function (AMF) of the core network and the UE. When a UE switches between CUs, an updated security key is derived. The handover dynamics may be designed to limit a network node's ability to know security keys for other network nodes. An initial key is derived by the AMF and provided to a first node of a first CU (source node). During handover, the source node provides the current UE security capabilities and a new key to a second node of a second CU (target node). The new key is derived by the source node for the target node.

The new key for the target node may be derived using either a horizontal derivation or a vertical derivation. For a horizontal derivation, the new key may be derived from the previous key, a next hop (NH) parameter, a physical cell ID (PCI) and a DL frequency (ARFCN-DL). For a vertical derivation, the new key may be derived from the previous key and a NH/next hop chaining counter parameter (NCC) pair. The UE derives the new security key based on the NCC. If the NCC is the same, then horizontal key derivation may be used. If the NCC is different, the UE may derive the NH until the NCC matches (with each increment). After the handover is complete, the target network node informs the AMF of the handover with a PATH SWITCH complete message. The AMF creates a fresh set of NH/NCC. The AMF provides the new NH/NCC to the target network node.

Inter-CU handover in a SN is technically called a SN change (rather than a handover) and security is handled differently than a conventional handover. The SN change may be SN-initiated, where the current SN decides to make the SN change, or MN-initiated, where the MN decides that the current SN is to be replaced. Both types of SN change have the same requirements from a security handling perspective.

The security key for an SN, K_{SN}, is based on the key used in the MN, K_{MN}. K_{SN} may be derived based on K_{MN} and the parameter SN Counter. The SN Counter is a 16-bit counter maintained by the MN that comprises an input to the K_{SN} derivation. The MN sets the SN Counter to ‘O’ when a new AS root key, K_{NG-RAN}, in the associated 5G AS security context is established. The SN Counter value ‘0’ is used to calculate the first K_{SN}. The MN may set the SN Counter to ‘1’ after the first calculated K_{SN}, and monotonically increment it for each additional calculated K_{SN}.

The MN derives the K_{SN} for a SN and directly provides this to the SN. The SN may not have access to the SN Counter. The MN sends the SN Counter to the UE, and UE derives the K_{SN} from the SN Counter.

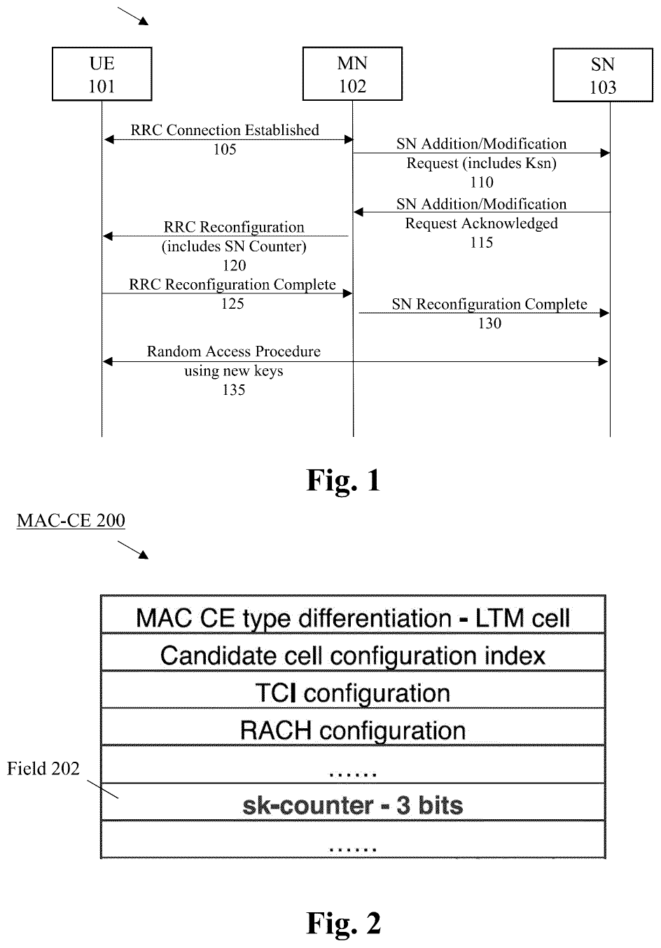

FIG. 1 shows an example signaling diagram 100 for addition/modification of a secondary node (SN) in dual-connectivity (DC) operations according to existing specifications. The signaling diagram 100 is described with regard to the security dynamics involved in adding/modifying a SN and includes a UE 101, a master node (MN) 102 and a secondary node (SN) 103.

In 105, the UE 101 and the MN 102 establish an RRC connection. During the RRC connection establishment, the UE 101 may indicate support of NR-DC. After the RRC connection is established, the MN 102 may decide to add the SN 103 so that the UE 101 may operate in NR-DC. The MN 102 may derive the security key for the SN 103 (K_{SN}) based on its security key (K_{MN}) and the parameter SN Counter.

In 110, the MN 102 sends a SN Addition/Modification request to the SN 103 over a backhaul interface (e.g., the Xn-C interface). The request may include the derived K_{SN}, security capabilities of the UE, and other information. The SN 103 may allocate resources, choose ciphering/integrity algorithms based on UE security capabilities, and derive RRC/UP keys based on K_{SN}.

In 115, the SN 103 sends a SN Addition/Modification acknowledgement to the MN 102 over the Xn-C indicating availability of requested resources, identifiers for the selected algorithm(s) for the requested Data Radio Bearers (DRBs) and/or Signaling Radio Bearer (SRB) for the UE, and other information.

In 120, the MN 102 sends an RRC Reconfiguration request to the UE 101 instructing the UE 101 to configure new DRBs and/or SRB for the SN 103. The request may include the SN counter parameter to indicate a new K_{SN} is needed. Based on the SN counter, the UE may derive the K_{SN}. The UE may additionally derive the RRC/UP keys from the K_{SN}, activate the RRC/UP protection, etc.

In 125, the UE 101 sends an RRC Reconfiguration Complete to the MN 102. The UE 101 may activate encryption/decryption and integrity protection keys with the SN 103.

In 130, the MN 102 sends a SN Reconfiguration Complete to the SN 103 over the Xn-C. The SN 103 may activate encryption/decryption and integrity protection keys with the UE 101, or may do so after receiving the Random Access request from the UE.

In 135, the UE 101 and the SN 102 perform the random access procedure using the new keys and the UE 101 may operate in NR-DC mode with the MN 102 and the SN 103.

If the MN 102 decides to configure conditional primary secondary cell (PSCell) addition/change (CPAC), and if there is more than one candidate SN, the MN 102 may derive a different K_{SN} for each SN and deliver the K_{SN} to each SN separately.

In an SN change scenario, the security dynamics remain the same as that described above. The MN 102 may send an SN Addition/Modification request to a further SN including a further K_{SN} derived based on the K_{MN} and an incremented SN counter. The new SN counter may be sent to the UE 101 to derive the new K_{SN}.

As described above, a typical handover is triggered by layer 3 (L3) measurements and is performed via radio resource control (RRC) signaling. The L3 handover requires reconfiguration of upper layers (e.g., RRC or PDCP) and/or resetting of lower layers (e.g., PHY or MAC).

Lower layer triggered mobility (LTM) was introduced in Rel-18 to support a serving cell change via L1 or L2 signaling. In LTM, a reconfiguration of upper layers is not required and minimal changes are made to the configuration of the lower layers, thus reducing the latency and overhead of the handover process.

In Rel-18, a LTM switch may be triggered by a L2 MAC-CE. The LTM switch of Rel-18 is only for intra-CU. Because the CU remains the same, there is no change in security keys or context and no change in PDCP. The LTM switch may be inter-DU (RLC and MAC reset) or intra-DU (MAC reset alone). The UE confirms the L2 trigger with a L3 RRC message (RRCReconfigComplete). No RRC messages to the UE are expected between LTM cell switches, even for subsequent LTM switches.

In Rel-19, it is an objective to support inter-centralized unit (CU) LTM for a SN. In some cases, the LTM cell switch may be based on MAC-CE and no RRC message is to be provided to the UE to help derive the K_{SN}. In other cases, e.g., UE triggered inter-CU within SN, even the MAC-CE is not used.

Accordingly, solutions should be devised such that the security requirements are met without RRC messages and in some cases without MAC CE messages as well.

According to various example embodiments, operations are described for security handling for an inter-CU SN change with a LTM trigger.

In some aspects of these example embodiments, a new MAC-CE may be used to carry a counter parameter for the UE to derive the security key to use for communications with a target SN. The counter parameter may be referred to herein as “sk-counter”. However, the counter parameter may be referred to by a different name.

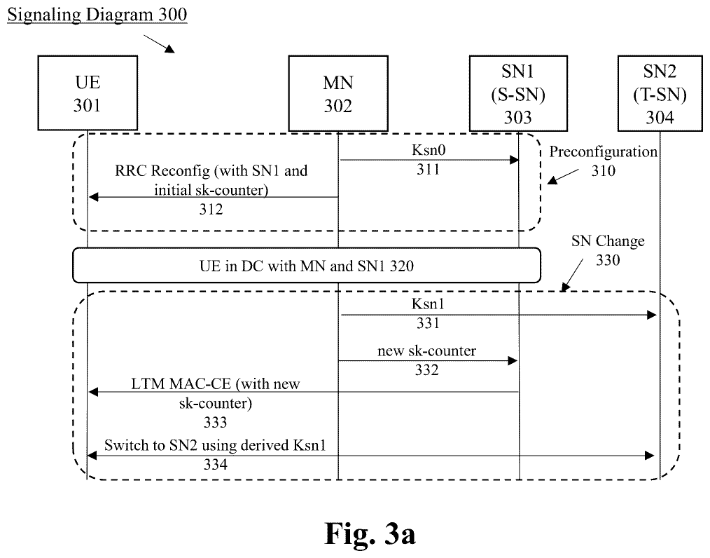

FIG. 2 shows an example MAC-CE 200 for triggering a secondary node (SN) change and providing a counter value according to various example embodiments. The MAC-CE 200 may be based on the existing MAC-CE for LTM switching and includes fields for indicating the LTM switch, the candidate cell configuration index, Transmission Configuration Indicator (TCI) configuration, Random Access Channel (RACH) configuration, etc. Relative to the existing MAC-CE, the MAC-CE 200 is modified to include a field 202 for a counter parameter (e.g., sk-counter). The counter field 202 may comprise 3 bits for indicating one of eight potential counter values. In other embodiments, the counter field 202 may comprise a different number of bits.

Similar to the SN counter described above for existing security handling in inter-SN handover, the sk-counter may be used by a MN to derive a security key for a SN. The security key for the SN, K_{SN}, may be derived by the MN based on the security key for the MN, K_{MN}, and the sk-counter. The K_{SN} may be provided directly to the SN, while the sk-counter is provided to the UE so that the UE may derive the K_{SN} based on the K_{MN} and the sk-counter.

In another aspect of these example embodiments, when the MN decides to switch the SN for a UE from a source SN to a target SN, an updated sk-counter may be provided to the source SN for the source SN to provide to the UE in the new MAC-CE. The MN may provide the new security key K_{SN} to the target SN directly, and the UE may derive the new security key from the K_{MN} and the sk-counter.

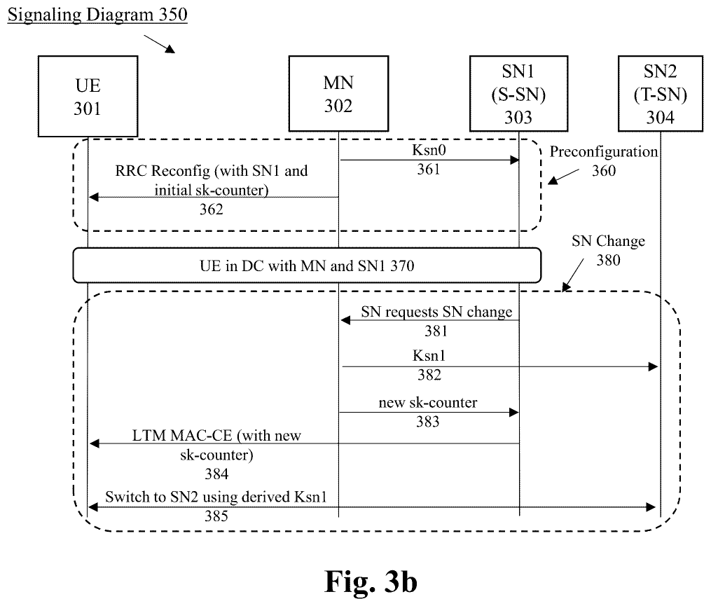

FIG. 3a shows a signaling diagram 300 for an inter-CU secondary node (SN) change initiated by a master node (MN) for a user equipment (UE) in NR-DC operation, the SN change being triggered by a MAC-CE in a lower layer triggered mobility (LTM) operation, according to various example embodiments. The signaling diagram 300 includes a UE 301, a master node (MN) 302, a first secondary node (SN1) 303, and a second secondary node (SN2) 304. In the SN change described below, the SN1 303 is a source SN (s-SN) and the SN2 304 is a target SN (t-SN). In this example, the SN change is initiated by the MN 302.

In a pre-configuration stage 310, the MN 302 configures the UE 301 and the SN1 303 for NR-DC operation. In 311, the MN 302 derives a security key for the SN1 303 (K_{SN0}) based on an initial sk-counter and provides the key directly to the SN1 303. The K_{SN0} may be provided in a SN Addition/Modification request to the SN1 303, similar to the signaling diagram 100 of FIG. 1 for existing operations.

In 312, the UE receives an RRC reconfiguration instructing the UE 301 to configure new DRBs and/or SRB for the SN1 303. In this example embodiment, the RRC reconfiguration includes the initial sk-counter value for the UE 301 to derive the K_{SN0}. With the derived K_{SN0}, the UE 301 may derive the RRC/UP keys, etc., and attempt random access with the SN1 303. The MN 302 may also configure one or more candidate SNs for the UE 301 for a LTM switch, the candidate SNs including the SN2 304.

In 320, the UE 301 is in NR-DC mode with the MN 302 and the SN1 303. While the UE 301 is operating in the NR-DC mode, the MN 302 may decide to perform an SN change for the UE 301 from the SN1 303 to the SN2 304.

In a LTM SN change stage 330, the MN 302 initiates the LTM SN change from the SN1 303 (s-SN) to the SN2 304 (t-SN). In 331, the MN 302 provides a second SN security key, K_{SN1}, to the SN2 304 (target SN) derived based on a new sk-counter. Similar to 311, the new key K_{SN1} may be included in a SN Add/Mod Request sent to the SN2 304. In 332, the MN 302 provides the new sk-counter to the SN1 303. The new sk-counter may be included in a SN Add/Mod Request sent to the SN1 303.

In 333, the UE 301 receives a LTM MAC-CE from the SN1 303 (source SN) for triggering the switch to the SN2 304. The MAC-CE includes the new sk-counter for the UE 301 to derive K_{SN1}. With the derived K_{SN1}, the UE 301 may derive the RRC/UP keys, etc., and attempt random access with the SN2 304. In 334, the UE 301 completes the switch to the SN2 304.

After completing the switch, the UE 301 may retain the configuration for the SN1 303. Thus, the MN 301 may initiate a second LTM SN change back to the SN1 303 or to a different SN provided in the candidate cell configuration without any further RRC messages. In another LTM SN change stage, the MN 301 may derive another new key for the next target SN based on another new sk-counter and provide the new sk-counter to the SN2 304 for delivery to the UE 301 to trigger the next SN change.

FIG. 3b shows a signaling diagram 350 for an inter-CU secondary node (SN) change initiated by a SN for a user equipment (UE) in NR-DC operation, the SN change being triggered by a MAC-CE in a lower layer triggered mobility (LTM) operation, according to various example embodiments. The signaling diagram 350 includes the UE 301, the MN 302, the SN1 303, and the SN2 304, similar to the diagram 300. In this example, the SN change is initiated by the SN1 303.

A pre-configuration stage 360 may be similar to the pre-configuration stage 310 of FIG. 3a and includes the MN 302 providing K_{SN0} to the SN1 303 (in 361) and the initial sk-counter value to the UE 301 (in 362). In 370, the UE 301 is in NR-DC mode with the MN 302 and the SN1 303, similar to 320. While the UE 301 is operating in NR-DC mode, the SN1 303 may decide to perform an SN change for the UE 301 from the SN1 303 to the SN2 304.

In a LTM SN change stage 380, the SN1 303 initiates the LTM SN change from the SN1 303 (s-SN) to the SN2 304 (t-SN). In 381, the SN1 303 requests the MN 302 to perform the SN change. The MN 302 may decide to grant the request. Similar to 331-334 in the diagram 300 above, the MN 301 may derive K_{SN1} based on a new sk-counter and provide K_{SN1} to the SN2 304 (target SN) (in 382); the MN 302 may provide the new sk-counter to the SN1 303 (in 383); the SN1 303 may send to the UE 301 a LTM MAC-CE including the new sk-counter for triggering the switch to the SN2 304 (in 384); and the UE 301 may complete the switch to the SN2 304 (in 385).

It is noted that the MAC-CE according to the above embodiments may not be protected by ciphering or integrity protection. Thus, the new sk-counter may be known by eavesdroppers and/or the SN2 304, which may be a potential security issue.

In other aspects of these example embodiments, a new MAC-CE may be used to carry a counter index parameter that maps to a counter parameter for the UE to derive the security key for the target SN. The MN may “randomize” the sk-counter with a lookup table. The table may be provided to the UE in RRC configuration (protected) and the SN is not aware of this table. The MN may provide an index value to the used sk-counter (not the actual sk-counter) to the SN to send to the UE via MAC CE.

To provide an illustrative example, the sk-counter table may comprise 8 entries (0-7) corresponding to a 3-bit field, sk-counter-index, in a new MAC-CE. Each index value may map to a random sk-counter value, e.g., index 0 maps to sk-counter 5, index 1 maps to sk-counter 4, index 2 maps to sk-counter 7, etc.

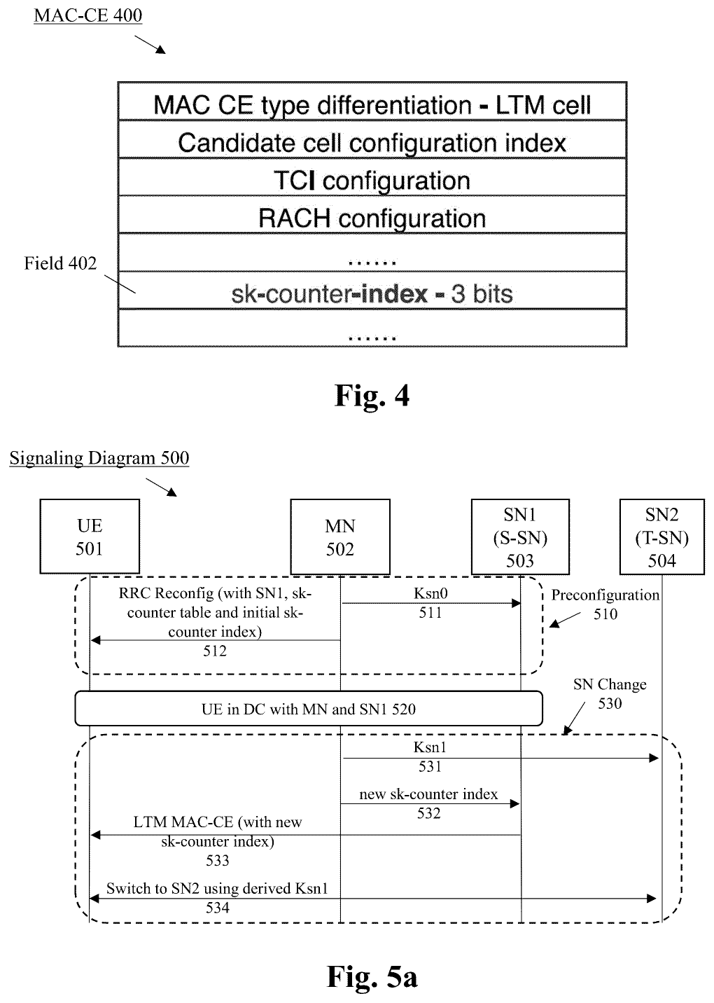

FIG. 4 shows an example MAC-CE 400 for triggering a secondary node (SN) change and providing a counter index value according to various example embodiments. The MAC-CE 400 is based on the existing MAC-CE for LTM switching and includes fields for indicating the LTM switch, the candidate cell configuration index, TCI configuration, RACH configuration, etc. Relative to the existing MAC-CE, the MAC-CE 400 is modified to include a field 402 for a counter index parameter (e.g., sk-counter-index). The counter index field 402 may comprise 3 bits for indicating one of eight potential index values, each index value mapping to a counter value. In other embodiments, the counter field 402 may comprise a different number of bits.

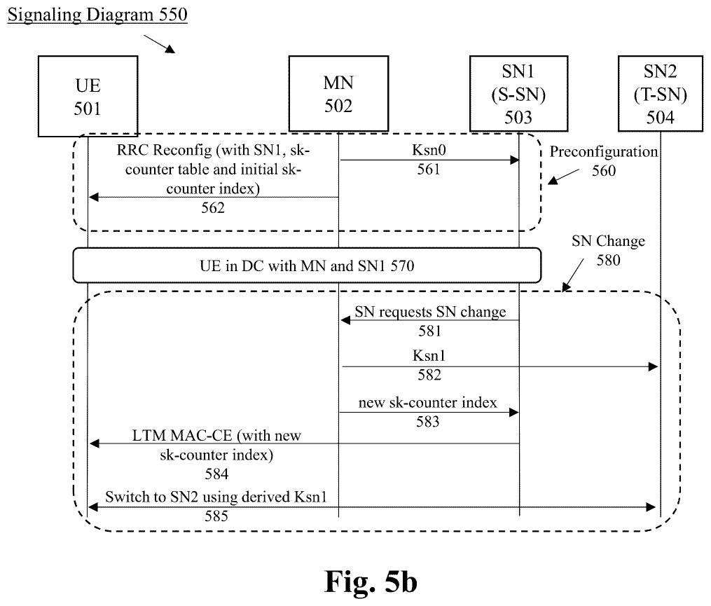

FIG. 5a shows a signaling diagram 500 for an inter-CU secondary node (SN) change initiated by a master node (MN) for a user equipment (UE) in NR-DC operation, the SN change being triggered by a protected MAC-CE in a lower layer triggered mobility (LTM) operation, according to various example embodiments. The signaling diagram 500 includes a UE 501, a master node (MN) 502, a first secondary node (SN1) 503, and a second secondary node (SN2) 504. In the SN change described below, the SN1 503 is a source SN (s-SN) and the SN2 504 is a target SN (t-SN). In this example, the SN change is initiated by the MN 502.

In a pre-configuration stage 510, the MN 502 configures the UE 501 and the SN1 503 for NR-DC operation. In 511, the MN 502 derives a security key for the SN1 503 (K_{SN0}) based on an initial sk-counter and provides the key directly to the SN1 503. The K_{SN0} may be provided in a SN Addition/Modification request to the SN1 503, similar to the signaling diagram 100 of FIG. 1 for existing operations.

In 512, the UE receives an RRC reconfiguration instructing the UE 501 to configure new DRBs and/or SRB for the SN1 503. In this embodiment, the RRC reconfiguration includes an sk-counter lookup table. The sk-counter lookup table may include a number of entries, e.g., 8 entries (index 0-7), with an associated sk-counter value. The RRC reconfiguration also includes an initial sk-counter-index value mapping to the initial sk-counter value used by the MN 502 to derive K_{SN0}. Thus, the UE 501 determines the initial sk-counter value from the initial sk-counter-index value and derives the K_{SN0}. With the derived K_{SN0}, the UE 501 may derive the RRC/UP keys, etc., and attempt random access with the SN1 503. The MN 502 may configure one or more candidate SNs for the UE 501 for a LTM switch, the candidate SNs including the SN2 504.

In 520, the UE 501 is in NR-DC mode with the MN 502 and the SN1 503. While the UE 501 is operating in the NR-DC mode, the MN 502 may decide to perform an SN change for the UE 501 from the SN1 503 to the SN2 504.

In a LTM SN change stage 530, the MN 502 initiates the LTM SN change from the SN1 503 (s-SN) to the SN2 504 (t-SN). The MN 502 derives a second SN security key, K_{SN1}, based on a new sk-counter value. The new sk-counter value maps to a new sk-counter-index value in the lookup table. In 531, the MN 502 provides a second SN security key, K_{SN1}, to the SN2 504 (target SN) derived based on a new sk-counter. Similar to 511, the new key K_{SN1} may be included in a SN Add/Mod Request sent to the SN2 504. In 532, the MN 502 provides the new sk-counter-index value to the SN1 503. The new sk-counter-index value may be included in a SN Add/Mod Request sent to the SN1 503.

In 533, the UE 501 receives a LTM MAC-CE from the SN1 503 (source SN) for triggering the switch to the SN2 504. The MAC-CE includes the new sk-counter-index value. The UE 501 determines the new sk-counter from the lookup table to derive K_{SN1}. With the derived K_{SN1}, the UE 501 may derive the RRC/UP keys, etc., and attempt random access with the SN2 504. In 534, the UE 501 completes the switch to the SN2 504.

After completing the switch, the UE 501 may retain the configuration for the SN1 503. Thus, the MN 502 may initiate a second LTM SN change back to the SN1 503 or to a different SN provided in the candidate cell configuration without any further RRC messages. In another LTM SN change stage, the MN 502 may derive another new key for the next target SN based on another new sk-counter mapping to a new sk-counter-index value and provide the new sk-counter-index value to the SN2 504 for delivery to the UE 501 to trigger the next SN change.

FIG. 5b shows a signaling diagram 550 for an inter-CU secondary node (SN) change initiated by a SN for a user equipment (UE) in NR-DC operation, the SN change being triggered by a protected MAC-CE in a lower layer triggered mobility (LTM) operation, according to various example embodiments. The signaling diagram 550 includes the UE 501, the MN 502, the SN1 503, and the SN2 504, similar to the diagram 500. In this example, the SN change is initiated by the SN1 503.

A pre-configuration stage 560 may be similar to the pre-configuration stage 510 of FIG. 5a and includes the MN 502 providing K_{SN0} to the SN1 503 (in 561) and the sk-counter lookup table and the initial sk-counter-index value to the UE 501 (in 562). In 570, the UE 501 is in NR-DC mode with the MN 502 and the SN1 503, similar to 520. While the UE 501 is operating in NR-DC mode, the SN1 503 may decide to perform an SN change for the UE 501 from the SN1 503 to the SN2 504.

In a LTM SN change stage 580, the SN1 503 initiates the LTM SN change from the SN1 503 (s-SN) to the SN2 504 (t-SN). In 581, the SN1 503 requests the MN 502 to perform the SN change. The MN 502 may decide to honor the request. Similar to 531-534 in the diagram 500 above, the MN 502 may derive K_{SN1} based on a new sk-counter and provide K_{SN1} to the SN2 504 (target SN) (in 582); the MN 502 may provide the new sk-counter-index to the SN1 503 (in 583); the SN1 503 may send to the UE 501 a LTM MAC-CE including the new sk-counter-index for triggering the switch to the SN2 504 (in 584); and the UE 501 may complete the switch to the SN2 504 (in 585).

It is noted that eavesdroppers and/or the SN2 504 could potentially read only the sk-counter-index and cannot know the actual sk-counter used.

In other aspects of these example embodiments, an inter-CU SN change may be performed without RRC or MAC CE signaling. In these embodiments, the UE may trigger the LTM cell switch, e.g., in a CPAC operation.

The UE may be provided with a “list” of sk-counters for each of one or multiple candidate SNs, which the UE may use sequentially. If the UE moves to one of the candidate SNs for the first time, the UE uses the first sk-counter from the list. If the UE then moves to a different candidate SN, the next time the UE moves back to the first SN, the UE uses the second sk-counter from the list. In one example, a first candidate SN with ID 0 is associated with a sk-counter list comprising 7,2,4,5,6 and a second candidate SN with ID 1 is associated with a sk-counter list comprising 3,4,2,1,5. The first candidate SN will use sk-counter 7 first, sk-counter 2 second, etc., and the second candidate SN will use sk-counter 3 first, sk-counter 4 second, etc.

At the network side, whenever there is a SN change, the MN is informed, e.g., by the UE, the source SN or the target SN. With this information, the MN may determine the next sk-counter to be used by the UE if the UE switches back to the (previous) source SN, derive the next K_{SN} for this SN, and provide the next K_{SN} to this SN. It is noted that a list of K_{SN} is not given to each SN.

In these embodiments, the network may avoid sending sk-counter or sk-counter-index in a MAC-CE to reduce MAC CE load/changes. The configuration provision is with RRC upfront, which is secure and slightly lower latency. Critically, it helps with UE triggered LTM cell switch where there is no DL MAC-CE.

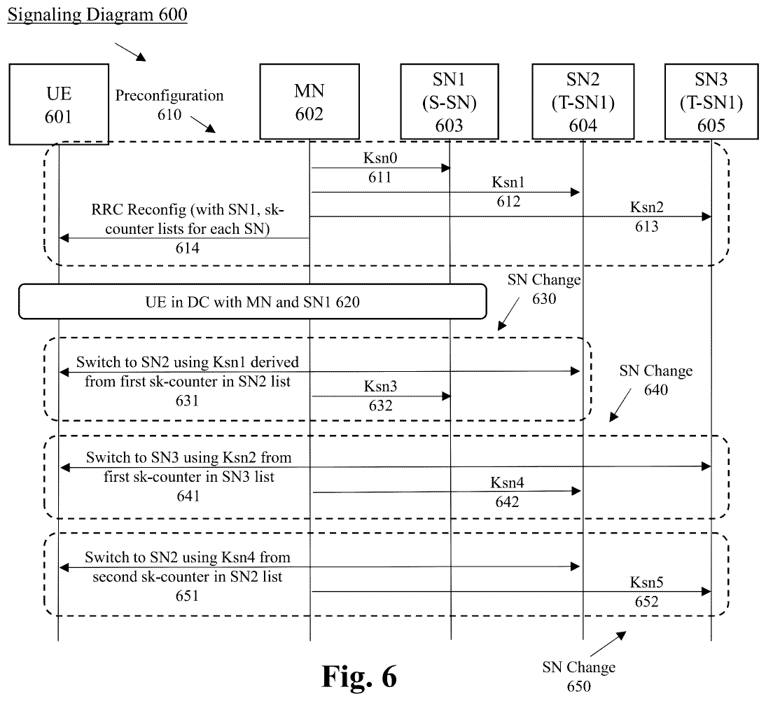

FIG. 6 shows a signaling diagram 600 for an inter-CU secondary node (SN) change initiated by a user equipment (UE) in NR-DC operation according to various example embodiments. The signaling diagram 600 includes a UE 601, a master node (MN) 602, a first secondary node (SN1) 603, a second secondary node (SN2) 604, and a third secondary node (SN3) 605. In the SN changes described below, the SN1 603 is a (initial) source SN (s-SN), the SN2 604 is a first target SN (t-SN1), and the SN3 605 is a second target SN (t-SN2). In this example, the SN changes are initiated by the UE 601.

In a pre-configuration stage 610, the MN 602 configures the UE 601 and the SN1 603 for NR-DC operation. In 611, the MN 602 derives an initial security key for the SN1 603 (K_{SN0}) based on a first sk-counter in a list of sk-counters for the SN1 603 and provides the key K_{SN0} directly to the SN1 603. The K_{SN0} may be provided in a SN Addition/Modification request to the SN1 603, similar to the signaling diagram 100 of FIG. 1 for existing operations. Additionally, the MN 602 derives an initial security key for the SN2 604 (K_{SN1}) based on a first sk-counter in a list of sk-counters for the SN2 604 and an initial security key for the SN3 605 (K_{SN2}) based on a first sk-counter in a list of sk-counters for the SN3 605. In 612, the MN 602 provides the key K_{SN1} directly to the SN2 604 and, in 613, the MN 602 provides the key K_{SN2} directly to the SN3 605

In 614, the UE receives an RRC reconfiguration instructing the UE 601 to configure new DRBs and/or SRB for the SN1 603. In this embodiment, the RRC reconfiguration includes an sk-counter list for the SN1 603. The sk-counter list may include a number of sk-counter values, e.g., 5 different sk-counter value. The UE 601 uses the first entry from the list the first time the UE 601 derives a key for the SN1 603 and, based on the first sk-counter, derives K_{SN0}. With the derived K_{SN0}, the UE 601 may derive the RRC/UP keys, etc., and attempt random access with the SN1 603. The MN 602 also configures one or more candidate SNs for the UE 601 for a LTM switch, the candidate SNs including the SN2 604 and the SN3 605, with their associated sk-counter lists.

In 620, the UE 601 is in NR-DC mode with the MN 602 and the SN1 603. While the UE 601 is operating in the NR-DC mode, the UE 601 may decide to perform an SN change from the SN1 603 to the SN2 604.

In a first SN change stage 630, the UE 601 initiates the SN change from the SN1 603 (s-SN) to the SN2 604 (t-SN1). The UE 601 derives the SN security key, K_{SN1}, based on a first sk-counter value in the list associated with SN2 604. With the derived K_{SN1}, the UE 601 may derive the RRC/UP keys, etc., and attempt random access with the SN2 604. In 631, the UE 601 completes the switch to the SN2 604. The MN 601 is informed of the switch, and, in 632, provides, based on a second sk-counter value in the list associated with SN1 603, a new key K_{SN3} to the SN1 603 to be used if the UE switches back to the SN1 603.

In a second SN change stage 640, the UE 601 initiates the SN change from the SN2 604 to the SN3 605 (t-SN2). The UE 601 derives the SN security key, K_{SN2}, based on a first sk-counter value in the list associated with SN3 605. With the derived K_{SN2}, the UE 601 may derive the RRC/UP keys, etc., and attempt random access with the SN3 605. In 641, the UE 601 completes the switch to the SN3 605. The MN 601 is informed of the switch, and, in 642, provides, based on a second sk-counter value in the list associated with SN2 604, a new key K_{SN4} to the SN2 604 to be used if the UE switches back to the SN2 604.

In a third SN change stage 650, the UE 601 initiates the SN change from the SN3 605 to the SN2 604. The UE 601 derives the SN security key, K_{SN4}, based on the second sk-counter value in the list associated with SN2 604. With the derived K_{SN4}, the UE 601 may derive the RRC/UP keys, etc., and attempt random access with the SN2 604. In 651, the UE 601 completes the switch back to the SN2 604. The MN 601 is informed of the switch, and, in 652, provides a new key K_{SN5} to the SN3 605 to be used if the UE switches back to the SN3 605.

In further aspects of these example embodiments, additional requirements may be imposed on the LTM operations described above.

In one embodiment, after every inter-CU LTM switch in SN, the UE sends in the RRCReconfigComplete msg (which is R18 behavior), the used sk-counter index to ensure that the sk-counters are aligned at the UE and at the MN. Alternatively, the UE may send the “next” sk-counter index to be used instead of the current used index.

In another embodiment, even when SRB3 is configured, the UE sends the RRCReconfigComplete msg to MN and not directly on SRB3.

In another embodiment, the network configures the UE to allow or not to send the RRCReconfigComplete msg to MN instead of SRB3.

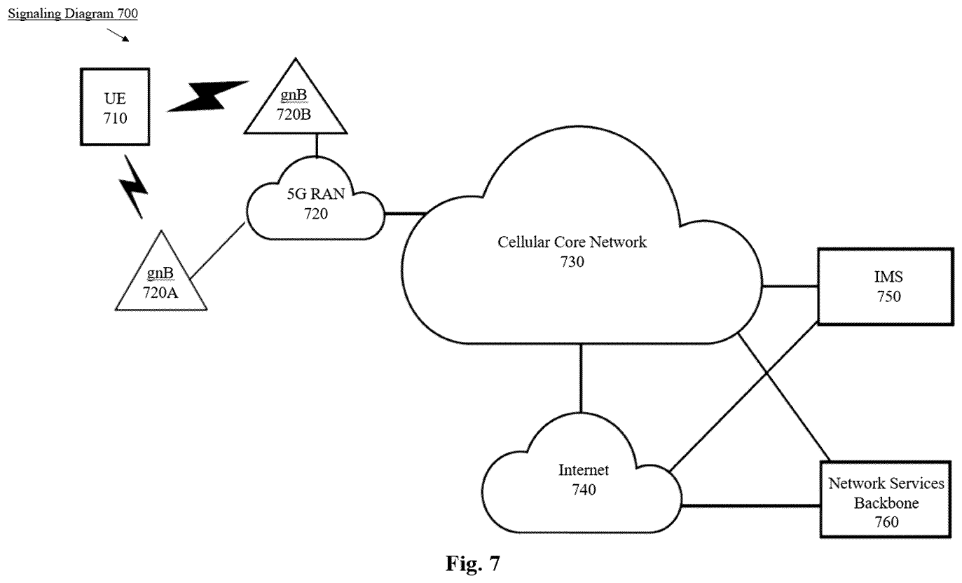

FIG. 7 shows an example network arrangement 700 according to various example embodiments. The example network arrangement 700 includes a UE 710. The UE 710 may be any type of electronic component that is configured to communicate via a network, e.g., mobile phones, tablet computers, desktop computers, smartphones, embedded devices, wearables, Internet of Things (IoT) devices, etc. An actual network arrangement may include any number of UEs being used by any number of users. Thus, the example of one UE 710 is merely provided for illustrative purposes.

The UE 710 may be configured to communicate with one or more networks. In the example of the network arrangement 700, the network with which the UE 710 may wirelessly communicate is a 5G NR radio access network (RAN) 720. However, the UE 710 may also communicate with other types of networks (e.g., 5G cloud RAN, a next generation RAN (NG-RAN), a legacy cellular network, etc.) and the UE 710 may also communicate with networks over a wired connection. With regard to the example embodiments, the UE 710 may establish a connection with the 5G NR RAN 720. Therefore, the UE 710 may have a 5G NR chipset to communicate with the NR RAN 720.

The 5G NR RAN 720 may be portions of a cellular network that may be deployed by a network carrier (e.g., Verizon, AT&T, T-Mobile, etc.). The RAN 720 may include cells or base stations that are configured to send and receive traffic from UEs that are equipped with the appropriate cellular chip set. In this example, the 5G NR RAN 720 includes the gNB 720A and the gNB 720B. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 710 to connect to the 5G NR RAN 720. For example, as discussed above, the 5G NR RAN 720 may be associated with a particular network carrier where the UE 710 and/or the user thereof has a contract and credential information (e.g., stored on a SIM card). Upon detecting the presence of the 5G NR RAN 720, the UE 710 may transmit the corresponding credential information to associate with the 5G NR RAN 720. More specifically, the UE 710 may associate with a specific cell (e.g., gNB 720A).

The network arrangement 700 also includes a cellular core network 730, the Internet 740, an IP Multimedia Subsystem (IMS) 750, and a network services backbone 760. The cellular core network 730 manages the traffic that flows between the cellular network and the Internet 740. The IMS 750 may be generally described as an architecture for delivering multimedia services to the UE 710 using the IP protocol. The IMS 750 may communicate with the cellular core network 730 and the Internet 740 to provide the multimedia services to the UE 710. The network services backbone 760 is in communication either directly or indirectly with the Internet 740 and the cellular core network 730. The network services backbone 760 may be generally described as a set of components (e.g., servers, network storage arrangements, etc.) that implement a suite of services that may be used to extend the functionalities of the UE 710 in communication with the various networks.

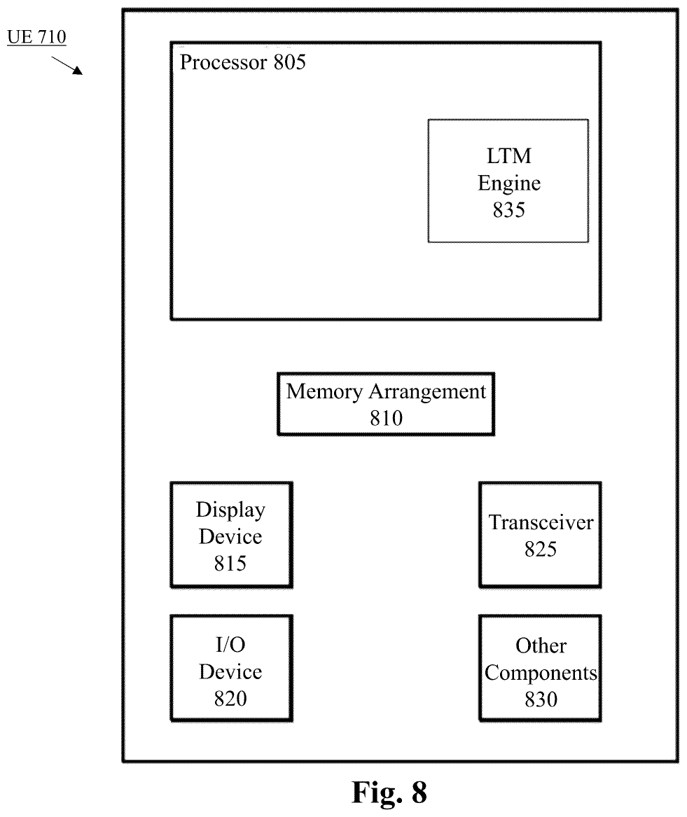

FIG. 8 shows an example UE 710 according to various example embodiments. The UE 710 will be described with regard to the network arrangement 700 of FIG. 7. The UE 710 may represent any electronic device and may include a processor 805, a memory arrangement 810, a display device 815, an input/output (I/O) device 820, a transceiver 825, and other components 830. The other components 830 may include, for example, an audio input device, an audio output device, a battery that provides a limited power supply, a data acquisition device, ports to electrically connect the UE 710 to other electronic devices, sensors to detect conditions of the UE 710, etc.

The processor 805 may be configured to execute a plurality of engines for the UE 710. For example, the engines may include a LTM engine 835 for performing operations related to performing a SN change based on a SN security key derived from a received/determined sk-counter, as described in detail above.

The above referenced engine being an application (e.g., a program) executed by the processor 805 is only an example. The functionality associated with the engines may also be represented as a separate incorporated component of the UE 710 or may be a modular component coupled to the UE 710, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 805 is split among two or more processors such as a baseband processor and an applications processor. The example embodiments may be implemented in any of these or other configurations of a UE.

The memory arrangement 810 may be a hardware component configured to store data related to operations performed by the UE 710. The display device 815 may be a hardware component configured to show data to a user while the I/O device 820 may be a hardware component that enables the user to enter inputs. The display device 815 and the I/O device 820 may be separate components or integrated together such as a touchscreen.

The transceiver 825 may be a hardware component configured to establish a connection with the 5G NR-RAN 720, an LTE-RAN (not pictured), a legacy RAN (not pictured), a WLAN (not pictured), etc. Accordingly, the transceiver 825 may operate on a variety of different frequencies or channels (e.g., set of consecutive frequencies). The transceiver 825 includes circuitry configured to transmit and/or receive signals (e.g., control signals, data signals). Such signals may be encoded with information implementing any one of the methods described herein. The processor 805 may be operably coupled to the transceiver 825 and configured to receive from and/or transmit signals to the transceiver 825. The processor 805 may be configured to encode, decode and/or process signals (e.g., signaling from a base station of a network) for implementing any one of the methods described herein.

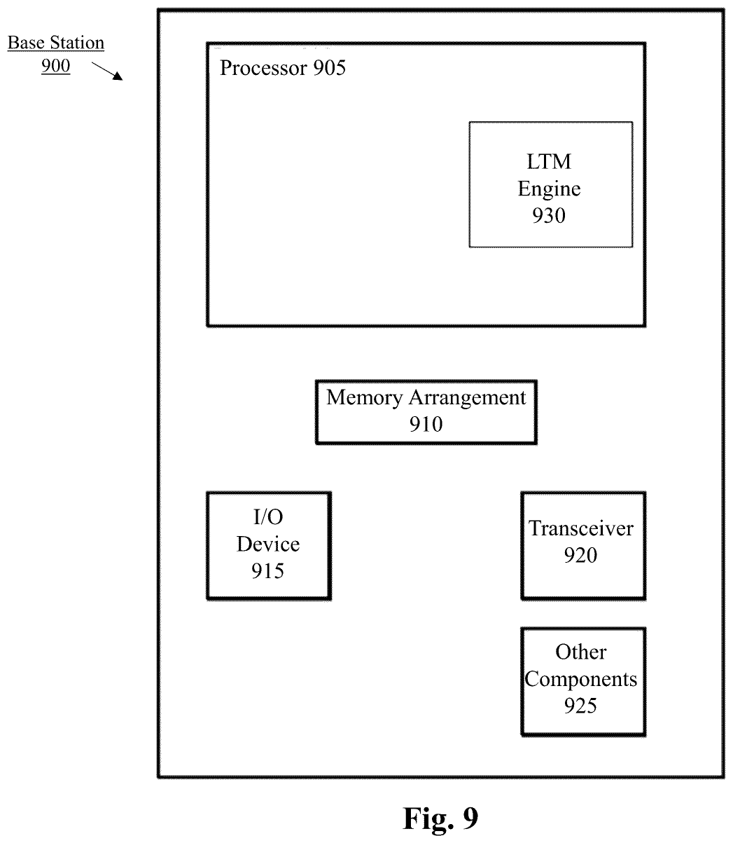

FIG. 9 shows an example base station 900 according to various example embodiments. The base station 900 may represent the gNB 720A, the gNB 720B or any other access node through which the UE 710 may establish a connection and manage network operations. The base station 900 may operate as the MN or the SN as described in the examples above.

The base station 900 may include a processor 905, a memory arrangement 910, an input/output (I/O) device 915, a transceiver 920, and other components 925. The other components 925 may include, for example, an audio input device, an audio output device, a battery, a data acquisition device, ports to electrically connect the base station 500 to other electronic devices and/or power sources, etc.

The processor 905 may be configured to execute a plurality of engines for the UE 710. For example, the engines may include an LTM engine 930 for performing operations related to security handling for an inter-CU SN change for a UE using LTM, e.g., MAC-CE, as described in detail above.

The memory arrangement 910 may be a hardware component configured to store data related to operations performed by the base station 900. The I/O device 915 may be a hardware component or ports that enable a user to interact with the base station 900.

The transceiver 920 may be a hardware component configured to exchange data with the UE 710 and any other UE in the network arrangement 700. The transceiver 920 may operate on a variety of different frequencies or channels (e.g., set of consecutive frequencies). The transceiver 920 includes circuitry configured to transmit and/or receive signals (e.g., control signals, data signals). Such signals may be encoded with information implementing any one of the methods described herein. The processor 905 may be operably coupled to the transceiver 920 and configured to receive from and/or transmit signals to the transceiver 920. The processor 905 may be configured to encode, decode and/or process signals (e.g., signaling from a UE) for implementing any one of the methods described herein.

### EXAMPLES

In a first example, a method comprising processing, based on signaling received from a master node (MN), a counter value for deriving a security key of a candidate secondary node (SN) and generating, for transmission to a user equipment (UE), a medium access control (MAC) control element (MAC-CE) that triggers a SN change to the candidate SN, the MAC-CE including the counter value for deriving the security key of the candidate SN.

In a second example, the method of the first example, wherein the counter value comprises an sk-counter.

In a third example, the method of the first example, the MAC-CE comprises a field carrying the counter value.

In a fourth example, the method of the third example, wherein the field in the MAC-CE carrying the counter value comprises 3 bits.

In a fifth example, the method of the first example, further comprising generating, for transmission to the MN, a request to perform the SN change.

In a sixth example, one or more processors configured to perform any of the methods of the first through fifth examples.

In a seventh example, a method comprising generating, for transmission to a secondary node (SN), a first security key wherein the first security key is generated based on an initial counter value, generating, for transmission to a user equipment (UE), a message comprising the initial counter value, determining the UE is to perform an SN change from the SN to a candidate SN, generating, for transmission to the candidate SN, a second security key wherein the second security key is generated based on a new counter value and generating, for transmission to the SN, the new counter value for deriving the second security key of the candidate SN.

In an eighth example, the method of the seventh example, wherein determining the UE is to perform an SN change is based on at least receiving a request to perform the SN change from the SN.

In a ninth example, the method of the seventh example, wherein the counter value comprises an sk-counter.

In a tenth example, the method of the seventh example, wherein the message comprises a list of counter values associated with the candidate SN.

In an eleventh example, one or more processors configured to perform any of the methods of the seventh through tenth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM);
process, based on signaling received from the SN, a medium access control (MAC) control element (MAC-CE) that triggers a SN change to a first candidate SN, the MAC-CE including a counter value for deriving a security key of the first candidate SN;
derive the security key for the first candidate SN based on the counter value; and
perform operations associated with the SN change from the SN to the first candidate SN.

2. The apparatus of claim 1, wherein the counter value comprises an sk-counter.

3. The apparatus of claim 1, the MAC-CE comprises a field carrying the counter value.

4. The apparatus of claim 3, wherein the field in the MAC-CE carrying the counter value comprises 3 bits.

5. An apparatus comprising processing circuitry configured to:
process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM) and a counter lookup table mapping counter index values to counter values;
process, based on signaling received from the SN, a medium access control (MAC) control element (MAC-CE) that triggers a SN change to a first candidate SN, the MAC-CE including a first counter index value;
determine a first counter value associated with the first counter index value for deriving a security key of the first candidate SN;
derive the security key for the first candidate SN based on the counter value; and
perform operations associated with the SN change from the SN to the first candidate SN.

6. The apparatus of claim 5, wherein the counter value comprises an sk-counter.

7. The apparatus of claim 5, the MAC-CE comprises a field carrying the counter value.

8. The apparatus of claim 7, wherein the field in the MAC-CE carrying the counter index value comprises 3 bits.

9. An apparatus comprising processing circuitry configured to:
process, based on signaling received from a first serving cell, a configuration for New Radio dual connectivity (NR-DC) operation in which the first serving cell is a master node (MN) and a second serving cell is a secondary node (SN), the configuration including at least one candidate SN for lower layer triggered mobility (LTM) and a respective list of counter values associated with each candidate SN;
determine to trigger a SN change to a first candidate SN;
derive a security key of the first candidate SN based on a first counter value in a first list of counter values associated with the first candidate SN; and
perform operations associated with the SN change from the SN to the first candidate SN.

10. The apparatus of claim 9, the processing circuitry further configured to:
determine to trigger a second SN change to a second candidate SN;
derive a security key of the second candidate SN based on a first counter value in a second list of counter values associated with the second candidate SN; and
perform operations associated with the second SN change from the first candidate SN to the second candidate SN.

11. The apparatus of claim 10, the processing circuitry further configured to:
determine to trigger a third SN change back to the first candidate SN;
derive a security key of the second candidate SN based on a second counter value in the first list of counter values associated with the first candidate SN; and
perform operations associated with the third SN change from the second candidate SN to the first candidate SN.

12. The apparatus of claim 9, wherein the counter values in the respective lists are used sequentially for each new switch to a candidate SN.
